(19) United States
(12) Patent Application Publication
(10) Pub. No.: US 2022/0282830 A1
(43) Pub. Date: Sep. 8, 2022

(54) LodeBand

(71) Applicant: Patrick William Jones, Dallas, TX (US)

(72) Inventor: Patrick William Jones, Dallas, TX (US)

(21) Appl. No.: 17/249,616

(22) Filed: Mar. 7, 2021

(51) Int. Cl. F16M 13/02; F16B 1/00

(52) U.S. Cl. CPC F16M 13/022; F16B 1/00; F16B 2001/0035

(57) ABSTRACT

Any system used for mounted storage of a device by a single magnetic attachment point on a fully dosed flexible band. The material for the fully closed flexible band can include, but is not limited to, elastic material such as rubber, elastic filaments, etc.

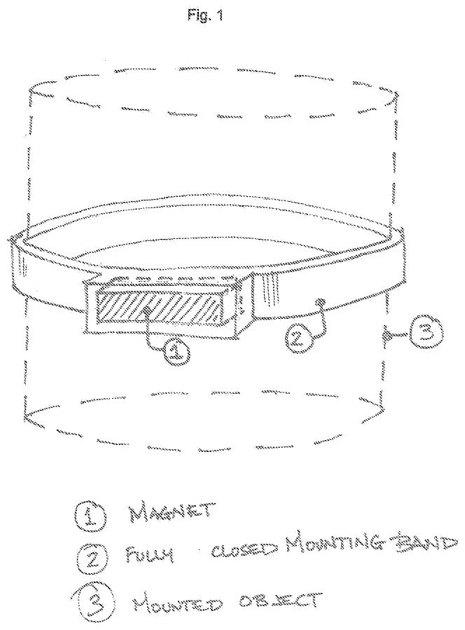

### CROSS-REFERENCE TO RELATED APPLICATIONS

Have not found any similar item In my searches of the database and online

### STATEMENT REGARDING FEDERALLY SPONSORED RESEARCH OR DEVELOPMENT

This invention is not part of any federally sponsored research or development project.

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention came out of a desire to be able to mount most any type of object easily. It includes a magnetic component combined with an elastic band to hold together and keep In place that object for easy storage. Based on the utility use of having the elastic/rubber band that allows for a fit to item grip and the attached magnet component allows for large varity of fit to item mounting options.

A magnetic wristband called the MagBand exists, but is not elastic and if focused toward holding screws and nails to your wrist and not as a mounting device.

### BRIEF SUMMARY OF THE INVENTION

This patent application is in pursuit of a utility patent for combining elastic/rubberband material with a magnet to create a fit to component magnetic attachment device. Depending on the size of the band and strength of the magnet—small items to large items can use this system to attach to any device that is attracted to the magnet to lock into place.

The LodeBand becomes a ready to fit, storage device that allows almost anything to be easily stored on any surface that is attracted to the magnet. In addition to storage, these bands also allow for a locking (magnetic) attachment to keep items closed together when paired.

### DETAILED DESCRIPTION OF THE INVENTION

See attachment “A” for a prototype display of the item in use. This prototype is constructed of an Industrial rubber band that has a rare earth magnet attached via super strong adhesive. Future versions may look to replace the adhesive with an formed mold that houses the magnet to allow for a greater lifespan for each band.

1. (canceled)

2. A fully dosed band mounting assembly, comprised of an elastic band with a primary magnetic attachment component allowing the assembly to mount to other, non-assembly, elements without the use of straps or secondary attachment magnet(s) as part of the assembly.

3. The closed band mounting assembly of claim 1, wherein the band element is self-tightening without need for strap, buckle, snap, or clasp.

4. The closed band mounting assembly of claim 1, wherein the band element has no ends but is a complete circular form.

5. The closed band mounting assembly of claim 1, wherein the primary magnetic attachment element may be comprised of one or more magnets to fulfill strength required to support devices from this primary attachment location.

6. The closed band mounting assembly of claim 1, wherein the band size and thickness of the band varies.

7. The closed band mounting assembly of claim 1, wherein the magnet varies in size and strength and shape.
